(19) United States
(12) Patent Application Publication
(10) Pub. No.: US 2026/0239124 A1
(43) Pub. Date: Aug. 13, 2026

(54) METHODS AND DEVICES FOR MITIGATING INTERFERENCE DURING HANDOVER

(71) Applicant: Telefonaktiebolaget LM Ericsson (publ), Stockholm (SE)

(72) Inventors: Jingye LI, Beijing (CN); Yongqian CHEN, Beijing (CN); Hongxi WANG, Beijing (CN)

(73) Assignee: Telefonaktiebolaget LM Ericsson (publ), Stockholm (SE)

(21) Appl. No.: 19/123,340

(22) PCT Filed: Nov. 2, 2022
(86) PCT No.: PCT/CN2022/129259

§ 371 Date: Apr. 22, 2025

(51) Int. Cl. H04W 36/00

(52) U.S. Cl. CPC H04W 36/0072; H04W 36/0058; H04W 36/0077

(57) ABSTRACT

There is provided a method implemented by a network device for mitigating interference during handover. The network device may determine there is a first user equipment (UE) to handover to a second cell, the second cell is a neighbor cell of the first cell. The network device may recognize a downlink resource position of a random access resource used by the second cell. The network device may also schedule a second UE of the first cell based on the downlink resource position of the random access resource, in a manner of mitigating the interference to the random access resource used by the second cell.

### TECHNICAL FIELD

The present disclosure generally relates to communication networks, and more specifically to methods and devices for mitigating interference during handover.

### BACKGROUND

Handover is a switching technique to ensure the terminal switching from the serving cell when it has poor radio frequency (RF) to other cells with good RF. Seamless handover is with best user equipment (UE) experience and cell key point indicator (KPI), but there always some cases would interrupt the handover procedure, such as interference. Since handover occurs at poor RF, the handover UE is more sensitive to the interference.

Current solutions mainly focus on power boosting on random access response (RAR) and contention resolution (CR) to increase its received signal to interference plus noise ratio (SINR), this could improve the handover quality but also could bring more interference to the serving cell.

Actually, the interference is mutually, higher power of serving cell would bring higher interference to handover UE, higher power of RAR and CR for handover UE bring more interference to the UEs at serving cell.

Suppress the interference is needed and one key way is to ensure RAR and CR SINR and not bring back more interference from the target cell.

### SUMMARY

The present disclosure proposes methods and devices for mitigating interference during handover to solve the above issues.

According to a first aspect of the present disclosure, there is provided a method implemented by a network device for mitigating interference during handover. The network device may determine there is a first user equipment (UE) to handover to a second cell, the second cell is a neighbor cell of the first cell. The network device may recognize a downlink resource position of a random access resource used by the second cell. The network device may also schedule a second UE of the first cell based on the downlink resource position of the random access resource, in a manner of mitigating the interference to the random access resource used by the second cell.

According to a second aspect of the disclosure there is provided a communication device in a communication network. The communication device may comprise a processor and a memory communicatively coupled to the processor. The memory may be adapted to store instructions which, when executed by the processor, cause the communication device to perform steps of the method according to the above first aspect.

According to a third aspect of the present disclosure, there is provided a non-transitory machine-readable medium having a computer program stored thereon. The computer program, when executed by a set of one or more processors of a communication device, causes the communication device to perform steps of the method according to the above first aspect.

### BRIEF DESCRIPTION OF THE DRAWINGS

The present disclosure may be best understood by way of example with reference to the following description and accompanying drawings that are used to illustrate embodiments of the present disclosure.

FIG. 1 illustrates a NG-RAN architecture of the New Radio (NR) network.

FIG. 2(a)-2(d) shows two types of random access procedure: 4-step RA type with MSG1 and 2-step RA type with MSGA.

FIG. 3 shows another random access procedure with fallback.

FIG. 4A and FIG. 4B illustrates two basic scenarios for interference to handover UE for AAS and non-AAS.

FIG. 4C provides a schematic diagram of the resource allocation for UE_s and UE_ho.

FIG. 5 illustrates a schematic diagram of the resource allocation for UE_s and UE_ho for a first method according to some embodiments of the present disclosure.

FIG. 6 provides a flow diagram for the first method for mitigating interference during handover according to some embodiments of the present disclosure.

FIG. 7 illustrates a schematic diagram of the resource allocation for UE_s and UE_ho for a second method according to some embodiments of the present disclosure.

FIG. 8 provides a flow diagram for the second method for mitigating interference during handover according to some embodiments of the present disclosure.

FIG. 9 illustrates a schematic diagram of the resource allocation for UE_s and UE_ho for a third method according to some embodiments of the present disclosure.

FIG. 10 provides a flow diagram for the third method for mitigating interference during handover according to some embodiments of the present disclosure.

FIG. 11 illustrates a schematic diagram of the resource allocation for UE_s and UE_ho for multi-cell scenario according to some embodiments of the present disclosure.

FIG. 12 illustrates an exemplary flow diagram 1200 for a method implemented by a network device of a first cell for mitigating interference during handover according to one or more embodiments of the present disclosure

FIG. 13 is a block diagram illustrating a communication device 1500 according to some embodiments of the present disclosure.

### DETAILED DESCRIPTION

The following detailed description describes methods and apparatuses for binding indication. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

As used herein, the terms “first”, “second” and so forth refer to different elements. The singular forms “a”, “an”, and “the” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “according to” is to be read as “at least in part according to”. The term “one embodiment” and “an embodiment” are to be read as “at least one embodiment”. The term “another embodiment” is to be read as “at least one other embodiment”.

Unless otherwise defined, all terms (including technical and scientific terms) used herein have the same meanings as commonly understood. It will be further understood that a term used herein should be interpreted as having a meaning consistent with its meaning in the context of this specification and the relevant art and will not be interpreted in an idealized or overly formal sense unless expressly so defined herein.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of or one or more physical network interfaces to establish network connections (to transmit and/or receive code and/or data using propagating signals) with other electronic devices. One or more parts of an embodiment of the present disclosure may be implemented using different combinations of software, firmware, and/or hardware.

In this disclosure, the term “communication device” means the electrical devices used in a communication network. For example, the communication device may be a user equipment or mobile station in any of the communication standard, such as 2G, 3G, 4G, 5G or beyond. For example, the communication device may be a base station, NodeB, eNB, or gNB in any of the communication standard, such as 2G, 3G, 4G, 5G or beyond. As an example, the communication device may be a core network device, such as Authentication Management Function (AMF) or Session Management Function (SMF), etc.

In this disclosure a term node is used which can be a network node or a UE. Examples of network nodes, which is also commonly known as network devices are NodeB, base station (BS), multi-standard radio (MSR) radio node such as MSR BS, eNodeB, gNodeB. MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, RRU, RRH, nodes in distributed antenna system (DAS), core network node (e.g. MSC, MME etc), O&M, OSS, SON, positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP) etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

An NG-RAN node is either:
a gNB, providing NR user plane and control plane protocol terminations towards the UE; or
an ng-eNB, providing E-UTRA user plane and control plane protocol terminations towards the UE.

The gNBs and ng-eNBs are interconnected with each other by means of the Xn interface. The gNBs and ng-eNBs are also connected by means of the NG interfaces to the 5GC, more specifically to the AMF (Access and Mobility Management Function) by means of the NG-C interface and to the UPF (User Plane Function) by means of the NG-U interface (see TS 23.501 [3]).

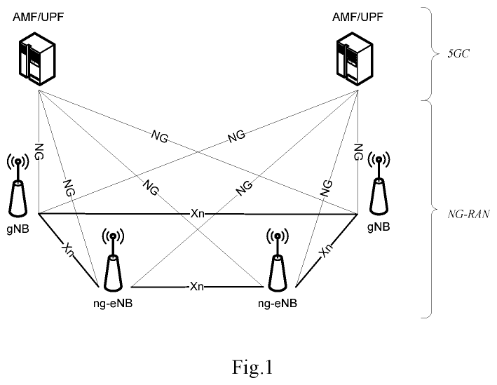

The NG-RAN architecture is illustrated in FIG. 1 below.

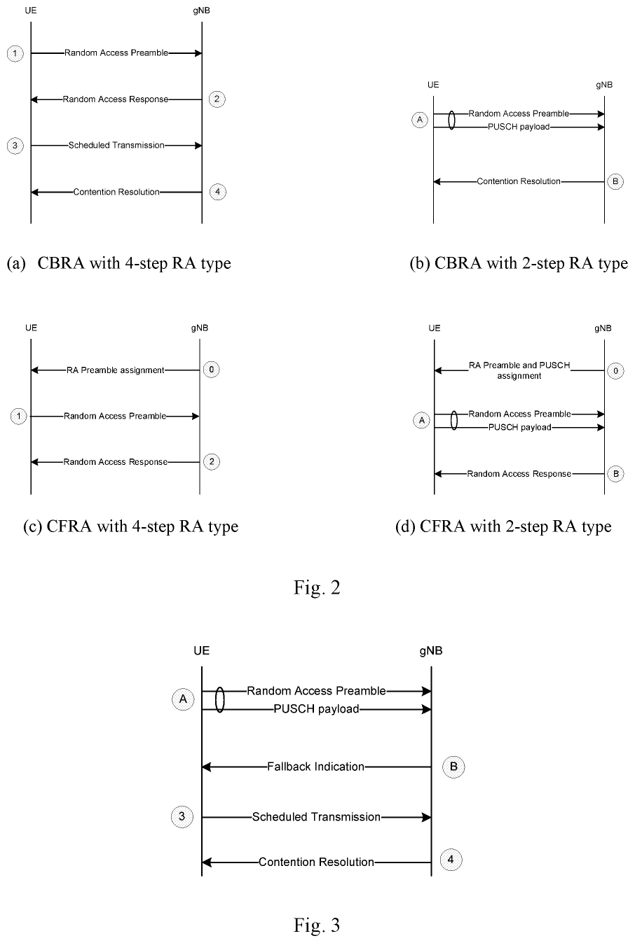

Two types of random access procedure are supported: 4-step RA type with MSG1 and 2-step RA type with MSGA. Both types of RA procedure support contention-based random access (CBRA) and contention-free random access (CFRA) as shown on FIG. 2 below.

The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.

The network does not configure CFRA resources for 4-step and 2-step RA types at the same time for a Bandwidth Part (BWP). CFRA with 2-step RA type is only supported for handover.

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as shown in FIG. 2(c). For CBRA, upon reception of the random access response, the UE sends MSG3 using the UL grant scheduled in the response and monitors contention resolution as shown in FIG. 2(a). If contention resolution is not successful after MSG3 (re)transmission(s), the UE goes back to MSG1 transmission.

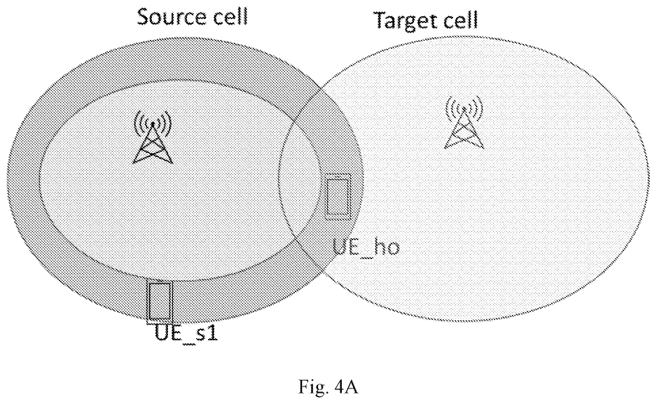

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in 2(d). For CBRA, if contention resolution is successful upon receiving the network response, the UE ends the random access procedure as shown in FIG. 2(b); while if fallback indication is received in MSGB, the UE performs MSG3 transmission using the UL grant scheduled in the fallback indication and monitors contention resolution as shown in FIG. 3. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution (Msg4).

The Physical Downlink Control Channel (PDCCH) can be used to schedule DL transmissions on PDSCH and UL transmissions on PUSCH. A UE monitors a set of PDCCH candidates in the configured monitoring occasions in one or more configured Control REsource SETs (CORESETs) according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs.

The msg2 and msg4 for RACH is transmitted in coreset on the downlink. The position of coreset0 is expressed as a resource block (RB) offset from the smallest RB index of the coreset0 to the smallest RB index of the common RB overlapping with the first RB of the SSB.

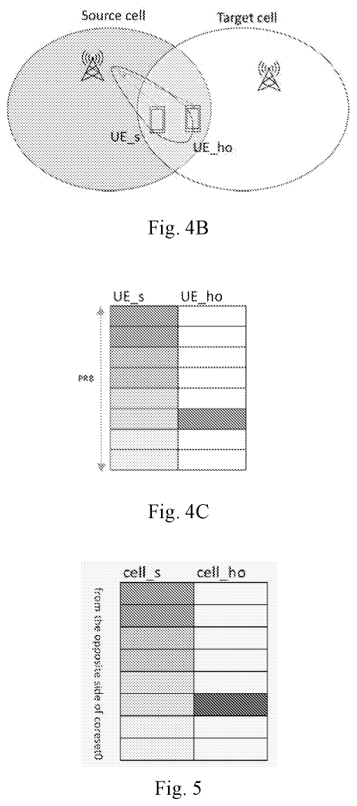

FIG. 4A and FIG. 4B illustrates two basic scenarios for interference to handover UE for AAS and non-AAS. When the traffic UE′ time-frequency resource overlaps with the UE_ho, it brings more interference to UE_ho on RAR and CR.

As depicted in FIG. 4A, for non-AAS scenario, such as 2, 4, 8 antennas, a UE (UE_s) with poor RF (such as at the edge) of the serving cell may provide interference to a handover UE (UE_ho), since the downlink traffic utilizes wide beam.

As depicted in FIG. 4B, for AAS scenario, such as 32 or 64 antennas, beamforming is enabled for downlink transmission. The UE (UE_s) in serving cell has small angle and small distance with the handover UE. Such UE_s will bring more interference to the handover UE. In field test, the interference would be about 10 dB, which cause the UE cannot connect to the target cell even with 3/6 power boost.

FIG. 4C provides a schematic diagram of the resource allocation for UE_s and UE_ho.

Our idea focuses on scenario: source cell has UEs with small angle and small distance with the handover UE. The beneficial use cases mainly include 1> mobility: serving UE with traffic and handover UE are on the same moving vehicle; 2> semi-mobility: serving UE with traffic stationary at cell edge of serving cell edge when UE is handing over to neighbor cells.

Due to the potential interference of the Handover UE on RAR and CR, we suggest the serving cell allocate lower load or no load on the RBGs overlapping with the coreset0 of the target cell. Since PDSCH of CRC shall in the range of coreset0, and CR would also in RB range of coreset0 when down link initial BWP not configured according to 3GPP 38.213 and 3GPP 38.212.

The method of the present disclosure can suppress the interference to RAR and CR of the handover UE, which could be with below benefit especially for cells without DL initial BWP configurated:
1. Increase the handover success rate, such as improve the random access rate of target cell when there is UE access at the poor FR;
2. Decrease UE drop rate;
3. The UE at poor RF facing less interference of RAR and CR from the neighbor cell.

The present disclosure provides three methods to mitigate interference during the handover. The method1-2 defines resource priority: serving cell would first cognitive the DL frequency position of the Handover UE on RAR and CR, and then allocate the frequency resource with lower priority to reduce the interference probability.

The method 3 clarifies the UE into different UE groups upon method1 and method2, UEs in the poor RF cannot be scheduled in the overlapping RBGs, and no restriction to the UEs at good RF.

From 3GPP 38.213 (section13), coreset0 maybe with different RBs, taking 100 MHz bandwidth and table 13-1 as example, the number of RB 24 is not integral multiple of RBGs, and even for 48 which is integral multiple of RBGs the start PRB may not aligned with RBG. When at this case, all the RBGs crossing coreset0 are named overlapping RBG.

TABLE 13-4
Set of resource blocks and slot symbols of CORESET
for Type0-PDCCH search space set when {SS/PBCH
block, PDCCH} SCS is {30, 30} kHz for
frequency bands with minimum channel bandwidth 5 MHz or 10 MHz

| | SS/PBCH block | | | |
|---|---|---|---|---|
| | and CORESET | Number of | Number of | |
| | Multiplexing | RBs | Symbols | |
| Index | pattern | N_{RB}^{CORESET} | N_{symb}^{CORESET} | Offset (RBs) |
| 0 | 1 | 24 | 2 | 0 |
| 1 | 1 | 24 | 2 | 1 |
| 2 | 1 | 24 | 2 | 2 |
| 3 | 1 | 24 | 2 | 3 |
| 4 | 1 | 24 | 2 | 4 |
| 5 | 1 | 24 | 3 | 0 |
| 6 | 1 | 24 | 3 | 1 |
| 7 | 1 | 24 | 3 | 2 |
| 8 | 1 | 24 | 3 | 3 |
| 9 | 1 | 24 | 3 | 4 |
| 10 | 1 | 48 | 1 | 12 |
| 11 | 1 | 48 | 1 | 14 |
| 12 | 1 | 48 | 1 | 16 |
| 13 | 1 | 48 | 2 | 12 |
| 14 | 1 | 48 | 2 | 14 |
| 15 | 1 | 48 | 2 | 16 |

According to one example, neighbor cell may have the same coreset0 frequency position as the serving cell. This is the common case in commercial networks.

According to another example, neighbor cell may have different coreset0 frequency position as the serving cell. This is not common in commercial network.

According to a first embodiment, the scheduling start direction is set from the opposite band of the coreset, this method is interference avoidance try best but with simple implementation. The schematic diagram of the resource allocation for UE_s and UE_ho is illustrated in FIG. 5.

As depicted in FIG. 5, the downlink resource position of random access resource of cell_ho is shown as dark black, which is nearer to the bottom side of the bandwidth. Thus, the resource blocks are allocated from top side of the bandwidth.

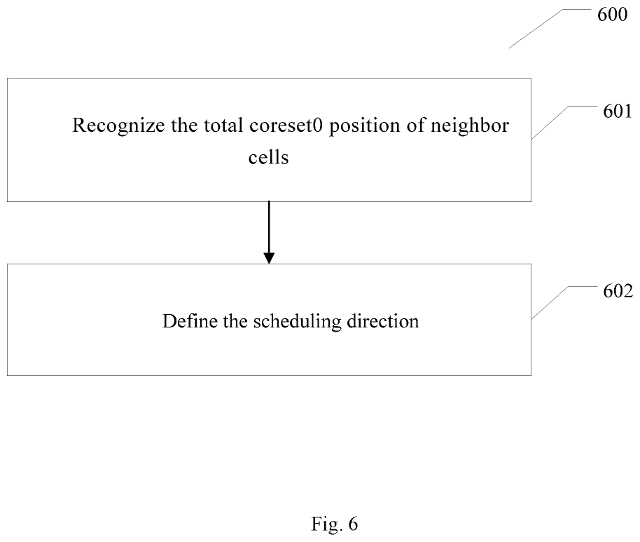

FIG. 6 provides a flow diagram 600 for a first method for mitigating interference during handover. In step 601, the total positions of neighbor cells are recognized. In step 602, the scheduling direction is defined. For neighbor cells with the same position of coreset0, one or more resource blocks may be allocated in a sequence order from one of bandwidth sides farther away from the downlink resource position of the random access resource. For neighbor cells with different positions of coreset0, the distances between each position and either one of bandwidth sides may be computed, and the scheduling start direction may be set based on the position of coreset0 with the farthest distance.

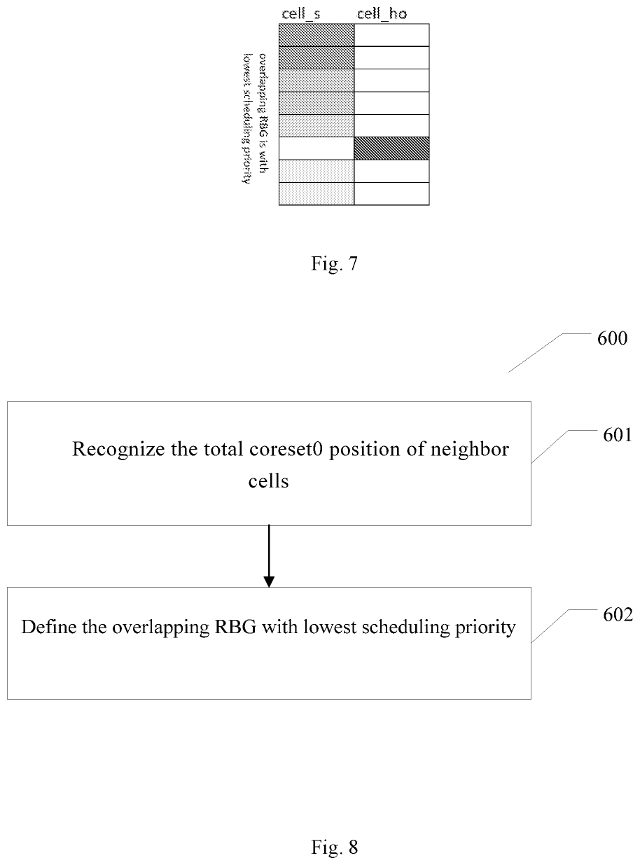

According to a second embodiment, the RBGs overlapping with coreset0 may be set with lowest scheduling weight, this method is also interference avoidance try best but smaller interference than the first embodiment. The schematic diagram of the resource allocation for UE_s and UE_ho is illustrated in FIG. 7.

As depicted in FIG. 7, the downlink resource position of random access resource of cell_ho is shown as dark black. The RBGs overlapping with coreset0 is set with lowest scheduling weight, which is shown as white color.

FIG. 8 provides a flow diagram 800 for a second method for mitigating interference during handover. In step 801, the total positions of neighbor cells are recognized. In step 802, the overlapping RBG is defined with lowest scheduling priority, one or more resource blocks may be allocated based on priority.

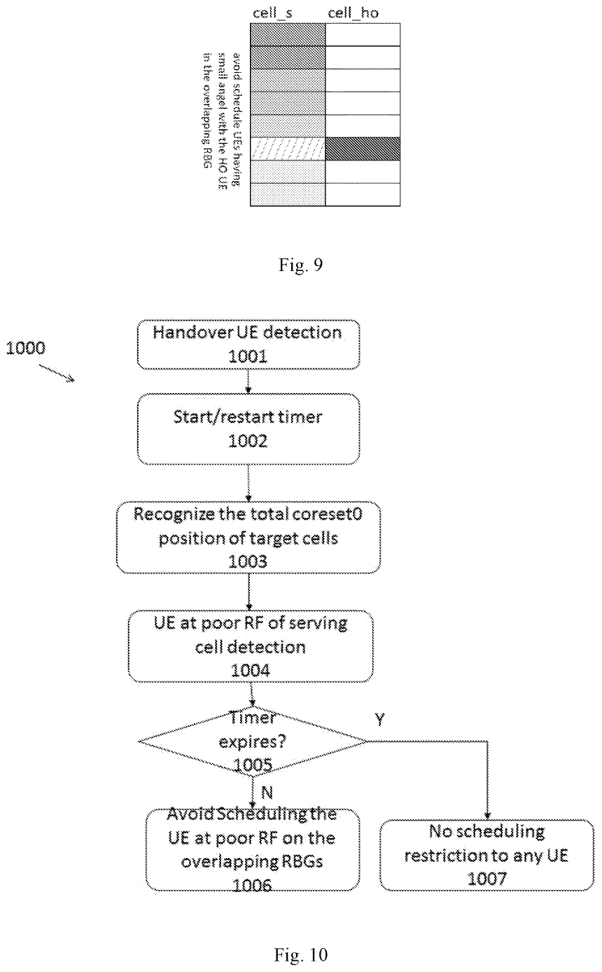

According to a third embodiment, the UEs are avoided scheduling at poor RF (this criterion includes UEs with small distance, either big angle or small angle) on the RBGs overlapping with coreset0. This method completely avoids the interference to the handover UE on RAR and CR. The schematic diagram of the resource allocation for UE_s and UE_ho is illustrated in FIG. 9.

3 steps are proposed for the third embodiment.

Initialize: all the UEs could be allocated on all the frequency resource.

Step1: UE_ho detection: Detect whether there is handover UE through handoverCommand signal, once detected, trigger step2 and step3, start the timer for step3.

There are several examples for the handover detection method.

According to the first example, determining there is a handover UE, if the UE reported measurement of source cell less than handover threshold.

According to the second example, determining there is a handover UE, if the measurement of target cell higher than predefined threshold.

According to the third example, determining there is a handover UE, if the load of source cell higher than threshold.

According to the fourth example, determining there is a handover UE from the handoverCommand signal of target cell or core network (CN).

Step3 can only be executed before the timer expires.

The timer could cover at least one RA latency (about 20 ms).

The timer could add offset to handle the HO signals.

If new HO event happen before the timer expires, restart the timer.

Step2: UE_s detection: Base station derive the downlink SINR, from reported CQI or RSRP, the UE is adjusted to be at poor RF and recorded as scheduleLimitUE, If the SINR less than pre-defined threshold; otherwise, the UEs are non scheduleLimitUE.

There are several examples for determining the serving UE at poor RF.

According to the first example, determining the serving UE at poor RF, if CQI value is lower than threshold.

According to the second example, determining the serving UE at poor RF, if rank value is lower than threshold.

According to the third example, determining the serving UE at poor RF, if PDSCH SINR derived from CQI is lower than threshold.

According to the fourth example, determining the serving UE at poor RF, if DL or UL BLER is higher than target BLER or threshold.

According to the fifth example, determining the serving UE at poor RF, if scheduled DL or UL MCS is lower than threshold.

The most important method is: using PMI distance of different UE to determine/estimate the correlation, such as when PMI distance <d then thinking the 2 UEs are with small angle and close to each other, then put the UE_s in to scheduleLimitUE group. This method could more narrow the UE_s range and using the resource of source cell more efficiently.

PMI distance is defined as: PMI_ues-PMI_ueho

Step3: Scheduling: scheduleLimitUE cannot be allocated on the RBGs overlapping with coreset0, non scheduleLimitUE has no limitation on the RBG position.

FIG. 10 provides a flow diagram 1000 for a third method for mitigating interference during handover.

In step 1001, whether there is a UE to handover is detected. In step 1002, start a timer for scheduling. In step 1003, total coreset0 position of target cells is recognized. In step 1004, UE at poor RF of serving cell is detected. In step 1005, determining whether the timer expires. In step 1006, the UE at poor RF of serving cell is scheduled based on the downlink resource position of the random access resource. In step 1007, there is no restriction to UEs of serving cell, when the timer expires.

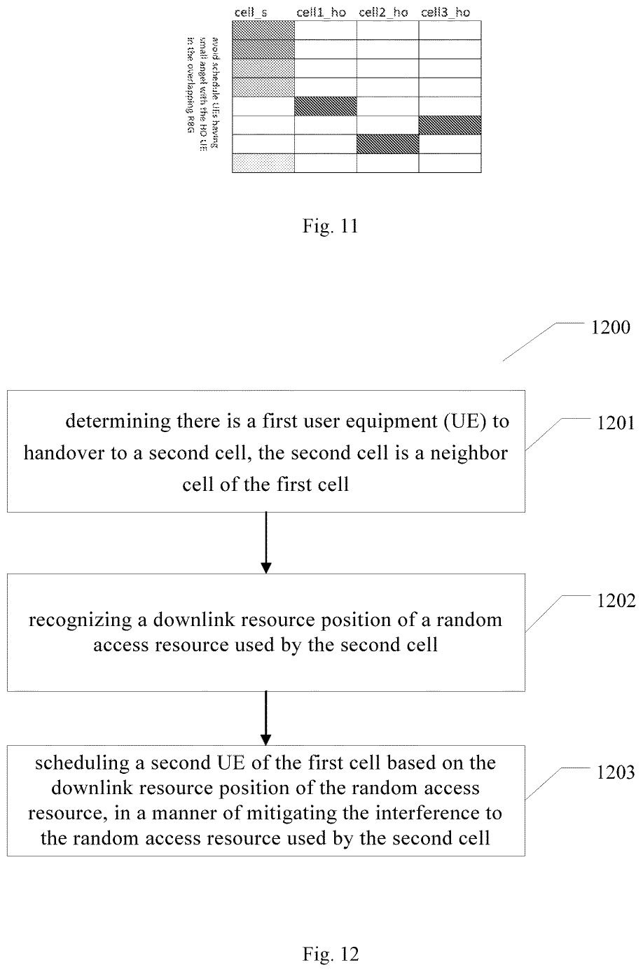

According to a fourth embodiment, neighbor cells have different coreset0 frequency positions as the serving cell. The schematic diagram of the resource allocation for UE_s and UE_ho is illustrated in FIG. 11. As depicted in FIG. 11, different coreset0 position is configured for different handover cells (cell1_ho, cell2_ho, cell3_ho). The base station needs first record the coreset0's positions of neighbor cells, and record the overlapping RBG as the total coreset0's frequency of all the neighbor cells and then adapts the above 3 methods. A gNB could derived the coreset0 position through below method: (1) through configured coreset0 of neighbor cells; (2) through the private IE over Xn interface between the gNBs.

As a first example, for cells with omnidirectional antennas, all the UE at cell edge are detected marked as resource limited UE, which can not be scheduled in the resource overlapping with overall coreset0 positions.

As a second example, for cells with directional antennas, only UEs with small distance and small angle with the handover UE are considered as interfering UEs. Thus, for each handover UE, different interfering UEs are detected. For each interfering UE, a mapping table of Handover UE, interference UE and interference avoidance resource is created. The method further comprises avoiding scheduling the interference UE in its interference avoidance resource.

FIG. 12 illustrates an exemplary flow diagram 1200 for a method implemented by a network device of a first cell for mitigating interference during handover according to one or more embodiments of the present disclosure.

With reference to FIG. 12, in step 1201, the method comprises determining there is a first user equipment (UE) to handover to a second cell, the second cell is a neighbor cell of the first cell. In step 1202, a downlink resource position of a random access resource used by the second cell is recognized. In step 1203, a second UE of the first cell is scheduled based on the downlink resource position of the random access resource, in a manner of mitigating the interference to the random access resource used by the second cell.

According to an embodiment, wherein determining there is a first user equipment (UE) to handover to a second cell further comprises: receiving a first UE measurement for the first cell in a UE measurement report from the first UE; and determining the first UE is to handover to the second cell, if the first UE measurement is less than a first handover threshold. As an example, the first UE measurement may include RSRP, RSRQ, SINR of the first UE.

According to an embodiment, wherein determining there is a first user equipment (UE) to handover to a second cell further comprises: receiving a second UE measurement for the second cell in a UE measurement report from the first UE; and determining the first UE is to handover to the second cell, if the second UE measurement is higher than a second handover threshold.

According to an embodiment, wherein determining there is a first user equipment (UE) to handover to a second cell further comprises: determining there is a first user equipment (UE) to handover to a second cell, if the first cell choose the first UE to handover to the second cell due to load balance.

According to an embodiment, wherein determining there is a first user equipment (UE) to handover to a second cell further comprises: determining there is a first user equipment (UE) to handover to a second cell, if receiving a handover command signal from a network device of the second cell.

According to an embodiment, wherein recognizing a downlink resource position of a random access resource used by the second cell further comprises: deriving the downlink resource position of the random access resource used by the second cell based on the configured coreset0 position of the second cell.

According to an embodiment, wherein recognizing a downlink resource position of a random access resource used by the second cell further comprises: receiving a random access resource IE over an Xn interface between the network device of the first cell and the network device of the second cell; and deriving the downlink resource position of the random access resource used by the second cell based on the random access resource IE.

According to an embodiment, wherein scheduling a second UE of the first cell based on the downlink resource position of the random access resource, in a manner of mitigating the interference to the random access resource used by the second cell comprises: allocating one or more resource blocks to the second UE in a sequence order from one of bandwidth sides farther away from the downlink resource position of the random access resource.

According to an embodiment, the method further comprises allocating one or more resource blocks to the second UE in a sequence order from any one of bandwidth sides, when downlink resource position of the random access resource is in the center of the bandwidth.

According to an embodiment, wherein scheduling a second UE of the first cell based on the downlink resource position of the random access resource, in a manner of mitigating the interference to the random access resource used by the second cell comprises: allocating one or more resource blocks to the second UE based on priority, wherein the resource block used by the first cell overlapping with the random access resource is assigned the lowest priority.

According to an embodiment, wherein scheduling a second UE of the first cell based on the downlink resource position of the random access resource, in a manner of mitigating the interference to the random access resource used by the second cell comprises: determining whether the second UE is an interfering UE to the first UE; marking the second UE as resource limited UE, if the second UE is an interfering UE to the first UE; and avoiding allocating one or more resource blocks used by the first cell overlapping with the random access resource to the second UE.

According to an embodiment, wherein determining whether the second UE is an interfering UE in the first cell further comprises: determining the second UE is an interfering UE by determining the second UE is at edge of the first cell.

According to an embodiment, wherein determining the second UE is at edge of the first cell further comprises any one of the followings: determining the second UE is at edge of the first cell, if the CQI value of the second UE is below a first cell edge threshold; determining the second UE is at edge of the first cell, if the rank value of the second UE is below a second cell edge threshold; determining the second UE is at edge of the first cell, if the PDSCH SINR of the second UE derived from its CQI value is below a third cell edge threshold; determining the second UE is at edge of the first cell, if the DL or UL BLER of the second UE is higher than a target BLER or BLER threshold; or determining the second UE is at edge of the first cell, if the scheduled DL or UL MCS of the second UE is lower than a MCS threshold.

According to an embodiment, wherein determining whether the second UE is an interfering UE to the first UE further comprises: computing PMI distance between the first UE and the second UE based on the PMI of the first UE and the PMI of the second UE; and determining the second UE is an interfering UE in the first cell, if the PMI distance between the first UE and the second UE is lower than a distance threshold.

According to an embodiment, the method further comprises: initializing a timer for scheduling when determining there is a first UE to handover to a second cell; and scheduling the second UE of the first cell by any one of the followings: scheduling the second UE of the first cell based on the downlink resource position of the random access resource in a manner of mitigating the interference to the random access resource used by the second cell, within the timer time; or scheduling the second UE of the first cell without considering the interference to the random access resource used by the second cell, when the timer expires.

According to an embodiment, the method further comprises: obtaining all downlink resource positions of the random access resource of all neighbor cells of the first cell.

According to an embodiment, wherein recognizing a downlink resource position of a random access resource used by the second cell further comprises: regarding all the obtained downlink resource positions as the downlink resource position of the random access used by the second cell.

According to an embodiment, wherein the random access resource used by the second cell is the coreset0 resource configured for the second cell.

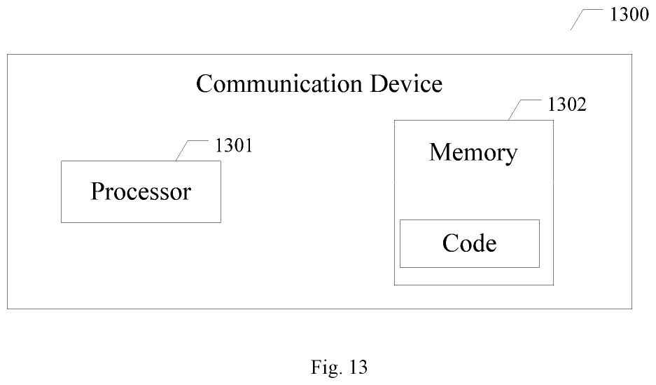

FIG. 13 is a block diagram illustrating a communication device 1300 according to some embodiments of the present disclosure. It should be appreciated that the communication device 1300 may be implemented using components other than those illustrated in FIG. 13.

With reference to FIG. 13, the communication device 1300 may comprise at least a processor 1301, a memory 1302, an interface and a communication medium. The processor 1301, the memory 1302 and the interface are communicatively coupled to each other via the communication medium.

The processor 1301 includes one or more processing units. A processing unit may be a physical device or article of manufacture comprising one or more integrated circuits that read data and instructions from computer readable media, such as the memory 1302, and selectively execute the instructions. In various embodiments, the processor 1301 is implemented in various ways. As an example, the processor 1301 may be implemented as one or more processing cores. As another example, the processor 1301 may comprise one or more separate microprocessors. In yet another example, the processor 1301 may comprise an application-specific integrated circuit (ASIC) that provides specific functionality. In yet another example, the processor 1301 provides specific functionality by using an ASIC and by executing computer-executable instructions.

The memory 1302 includes one or more computer-usable or computer-readable storage medium capable of storing data and/or computer-executable instructions. It should be appreciated that the storage medium is preferably a non-transitory storage medium.

The communication medium facilitates communication among the processor 1301, the memory 1302 and the interface. The communication medium may be implemented in various ways. For example, the communication medium may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium. The interface could be coupled to the processor. Information and data as described above in connection with the methods may be sent via the interface.

In the example of FIG. 13, the instructions stored in the memory 1502 may include those that, when executed by the processor 1301, cause the communication device 1300 to implement the methods described with respect to FIG. 12.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a network device of a first cell in a communication network, the method comprising:
determining there is a first user equipment (UE) to handover to a second cell, the second cell is a neighbor cell of the first cell;
recognizing a downlink resource position of a random access resource used by the second cell; and
scheduling a second UE of the first cell based on the downlink resource position of the random access resource, in a manner of mitigating the interference to the random access resource used by the second cell.

2. The method of claim 1, wherein determining there is the first UE to handover to a second cell further comprises:
receiving a first UE measurement for the first cell in a UE measurement report from the first UE; and
determining the first UE is to handover to the second cell, if the first UE measurement is less than a first handover threshold.

3. The method of claim 1, wherein determining there is the first UE to handover to a second cell further comprises:
receiving a second UE measurement for the second cell in a UE measurement report from the first UE; and
determining the first UE is to handover to the second cell, if the second UE measurement is higher than a second handover threshold.

4. The method of claim 1, wherein determining there is the first UE to handover to a second cell further comprises:
determining there is the first UE to handover to a second cell, if the first cell choose the first UE to handover to the second cell due to load balance.

5. The method of claim 1, wherein determining there is the first UE to handover to a second cell further comprises:
determining there is the first UE to handover to a second cell, if a handover command signal is received from a network device of the second cell.

6. The method of claim 1, wherein recognizing the downlink resource position of the random access resource used by the second cell further comprises: deriving the downlink resource position of the random access resource used by the second cell based on a configured coreset0 position of the second cell.

7. The method of claim 1, wherein recognizing the downlink resource position of the random access resource used by the second cell further comprises: receiving a random access resource IE over an Xn interface between the network device of the first cell and the network device of the second cell; and
deriving the downlink resource position of the random access resource used by the second cell based on the random access resource IE.

8. The method of claim 1, wherein scheduling the second UE of the first cell based on the downlink resource position of the random access resource, in a manner of mitigating the interference to the random access resource used by the second cell comprises:
allocating one or more resource blocks to the second UE in a sequence order from one of bandwidth sides farther away from the downlink resource position of the random access resource.

9. The method of claim 8, further comprising:
allocating one or more resource blocks to the second UE in a sequence order from any one of bandwidth sides, when downlink resource position of the random access resource is in the center of the bandwidth.

10. The method of claim 1, wherein scheduling the second UE of the first cell based on the downlink resource position of the random access resource, in a manner of mitigating the interference to the random access resource used by the second cell comprises:
allocating one or more resource blocks to the second UE based on priority, wherein the resource block used by the first cell overlapping with the random access resource is assigned the lowest priority.

11. The method of claim 1, wherein scheduling the second UE of the first cell based on the downlink resource position of the random access resource, in a manner of mitigating the interference to the random access resource used by the second cell comprises:
determining whether the second UE is an interfering UE to the first UE;
marking the second UE as resource limited UE, if the second UE is an interfering UE to the first UE; and
avoiding allocating one or more resource blocks used by the first cell overlapping with the random access resource to the second UE.

12. The method of claim 11, wherein determining whether the second UE is an interfering UE in the first cell further comprises:
determining the second UE is an interfering UE by determining the second UE is at edge of the first cell.

13. The method of claim 12, wherein determining the second UE is at edge of the first cell further comprises any one of:
determining the second UE is at edge of the first cell, if a CQI value of the second UE is below a first cell edge threshold;
determining the second UE is at edge of the first cell, if a rank value of the second UE is below a second cell edge threshold;
determining the second UE is at edge of the first cell, if a PDSCH SINR of the second UE derived from its CQI value is below a third cell edge threshold;
determining the second UE is at edge of the first cell, if a DL or UL BLER of the second UE is higher than a target BLER or BLER threshold; or
determining the second UE is at edge of the first cell, if a scheduled DL or UL MCS of the second UE is lower than a MCS threshold.

14. The method of claim 11, wherein determining whether the second UE is an interfering UE to the first UE further comprises:
computing PMI distance between the first UE and the second UE based on a PMI of the first UE and a PMI of the second UE; and
determining the second UE is an interfering UE in the first cell, if the PMI distance between the first UE and the second UE is lower than a distance threshold.

15. The method of claim 1, further comprising:
initializing a timer for scheduling when determining there is the first UE to handover to the second cell; and
scheduling the second UE of the first cell by any one of:
scheduling the second UE of the first cell based on the downlink resource position of the random access resource in a manner of mitigating the interference to the random access resource used by the second cell, within a timer time; or
scheduling the second UE of the first cell without considering the interference to the random access resource used by the second cell, when a timer expires.

16. The method of claim 1, further comprising:
obtaining all downlink resource positions of the random access resource of all neighbor cells of the first cell.

17. The method of claim 16, wherein recognizing the downlink resource position of the random access resource used by the second cell further comprises:
regarding all the obtained downlink resource positions as the downlink resource position of the random access used by the second cell.

18. The method of claim 1, wherein the random access resource used by the second cell is a coreset0 resource configured for the second cell.

19. A communication device in a communication network, comprises:
processing circuitry; and
a memory communicatively coupled to the processing circuitry and adapted to store instructions which, when executed by the processing circuitry, cause the communication device to perform steps of the method according to claim 1.

20. A non-transitory machine-readable medium having a computer program stored thereon, which when executed by processing circuitry of a communication device, causes the communication device to perform steps of the method according to claim 1.
